(19) United States
(12) Patent Application Publication
(10) Pub. No.: US 2012/0121322 A1
(43) Pub. Date: May 17, 2012

(54) BUTYL-FREE FREEZER PANEL JOINTS

(76) Inventor: Fred L. MINELLI, Carrollton, TX (US)

(21) Appl. No.: 13/294,455

(22) Filed: Nov. 11, 2011

Related U.S. Application Data
(60) Provisional application No. 61/413,955, filed on Nov. 15, 2010.

(51) Int. Cl. F16B 5/00

(52) U.S. Cl. 403/288

(57) ABSTRACT

A butyl-free freezer panel joint is obtained by use of at least a first compressible gasket of polyvinyl chloride disposed about the tongue of a tongue and groove panel joint, and the use of a second compressible gasket that is an adhesive-like material that lies between the first gasket and the tongue portion of the framing member of the panel joint.

### CROSS-REFERENCED APPLICATION

This non-provisional U.S. patent application is related to and claims the benefit of U.S. provisional application Ser. No. 61/413,955, filed Nov. 15, 2010, which is incorporated herein in its entirety by reference thereto.

### BACKGROUND

1. Field of the Disclosure

This disclosure relates generally to the field of butyl-free freezer panel joints. The disclosure also relates to butyl-free freezer panel joint assemblies comprised of an assemblage or fitting together of freezer panel joints and panels into complete walls, panels, structures or units. The joint assemblies seal the joints of freezer panels using, inter alia, a multi-component gasket that functions well as a sealant without the need for or use of a butyl sealant.

2. Discussion of Background Art

For many years, sealants for joining freezer and other panels have included butyl or butyl-containing materials, herein sometimes referred to “butyl sealants”. These materials have provided excellent, flexible, non-curing, non-drying, long-lasting vapor-proof sealed joints of freezers and other panels.

However, butyl sealants are not without their problems. They are tacky and difficult to apply. They are ever-wet. They do not dry out over long periods of time. During this time, they are very sticky and messy to apply and service. Applying butyl sealant materials whether in the factory or in the field is very exacting. It is therefore an object of this disclosure to resolve the problems presented by butyl sealants, by providing effective freezer panel joints that are butyl-free.

One such attempt to eliminate the need for butyl sealants is disclosed in co-pending US Patent Publication No. 2011/0173925 (Brown), entitled “Structural Insulated Panel System”. US Patent Publication No. 2011/0173925 discloses a structural insulated panel system includes a frame having a first and second vertical frame members and top and bottom frame members. First and second siding members are attached to opposite sides of the frame, the frame and the first and second siding members forming a cavity, with an insulation material within the cavity. The first vertical frame member includes recesses having a first depth and the second vertical frame member includes projections having a second depth. A first compressible seal is disposed within the recesses and is compressed by the projections of an adjacent panel upon assembly. A second compressible seal is disposed adjacent to each outside edge of the first or second vertical frame member and is compressed by the other frame member upon assembly. A plurality of voids are formed in at least one of the frame members and filled with the insulation fill material.

It is another object of this disclosure to resolve problems associated with butyl sealants by providing new and useful butyl-free freezer panel joint assemblies.

### SUMMARY

A freezer panel joint assembly that is butyl-free is provided, wherein a novel joint assembly is used to seal the joints of freezer panels.

The freezer panel joint assembly preferably comprises:

at least one first gasket of blown or foamed polyvinyl chloride (PVC), or the like, disposed about a tongue and groove panel joint, wherein the first gasket is affixed to at least a portion of the interfacing flat surfaces of the panel joint, preferably running near and along the outer edge of the elongated interfacing flat surface of the panel (P) of the framing member (FM) to either side of tongue T and/or groove (G); and

at least one second gasket that is sponge-like, spongy, or compressible that provides a spring-back feature, wherein the second gasket is affixed to at least a portion of the flat surface of the interfacing panel (P) of the framing member (FM) that lies between the first gasket and the tongue portion of the panel joint; and

the first and/or second gaskets being affixed to the interfacing flat surface portions of the joint of the framing member by any suitable chemical or mechanical fastener, e.g., an adhesive, preferably a strong adhesive, that adheres to a surface of the first and/or second gasket(s) and to the surfaces of the panels adjacent to the tongue portion.

The first gasket is preferably Norex® available under the product designations as P3930/P3931/PP3932 and/P3933. Norex® is a custom extruded PVC based foam polymer profile for general gasketing purposes. Norex® is supplied with an optional pressure-sensitive adhesive and paper release liner. The adhesive is an acrylic material for application to foam rubber adhesive liner side. Another suitable material is Norex® NSF, a special grade PVC foam polymer extrusion, approved by NSF International (national sanitation requirements). It is ideal for refrigeration cooler applications. These extrusions feature a “skin” which eliminates open surface cells, making them excellent for sanitary applications.

The second gasket is preferably Norprene®, a thermoplastic elastomer (TPE) with enhanced temperature and chemical resistance for demanding applications. Norprene® provides faster compression recovery than PVC foams. The above materials are available from Saint-Gobain Performance Plastics, located at Granville, N.Y. 12832. They are also available through Streamline Packaging Solutions, located at Grand Prarie, Tex.

Examples of preferred chemical fasteners are at least one adhesive selected from the group consisting of: a high tack adhesive that keeps foam in place during assembly operations. The preferred chemical fastener is an adhesive sold under the trademark Norseal® V730 by Saint-Gobain Performance Plastics. Norseal® V730 is an aqueous based acrylic pressure-sensitive adhesive. The adhesive is a high-tack positioning adhesive that grips tight on initial contact and keeps foam in place during assembly. The liner on the non-adhesive side keeps slit rolls from falling apart.

The second gasket is provided with an aggressive adhesive backing and is factory applied to the panel. Pressure is applied to the gasket, pressing it into position on the exterior side of the panel between the first gasket and the tongue. The aggressive adhesive holds the gasket in place through the manufacturing process and through the transportation process. The gasket is cut flush and lapped where it transitions from a vertical to a horizontal framing member. This ensures the full gasket thickness at these transitions. The gasket material and strength of adhesive are key factors as the panels may be exposed to extreme weather conditions during shipment and installation at the final installation site.

Another preferred adhesive is a John Deal transfer adhesive (JDC C500), ⅜^{th″} width. This adhesive can be obtained through John Deal Coatings, located in Mt. Juliet, Tenn. Their website is www.jdcinc.com.

Examples of mechanical fasteners are fasteners selected from the group consisting of: cam locks, screws, nails, brackets, etc.

### BRIEF DESCRIPTION OF THE DRAWINGS

FIG. 1 is a schematic representation with portions broken away of a freezer panel joint assembly according to one embodiment of the present invention with a pair of gaskets disposed on the outer edges of the framing member, wherein the tongue or male portion is disposed between the pair of first gaskets, and wherein a second gasket is disposed between the tongue or male portion and one of the first gaskets.

FIG. 1(a) is an enlarged view of a portion of first gasket as would be seen from the outer vertical edge of the framing member of FIG. 1.

FIG. 2 depicts a side perspective view of a panel joint assembly comprising a tongue and groove assembly with a cam-lock fastener according to the present disclosure.

FIG. 3 depicts various panel joint assemblies components according to the present disclosure for use in multi-panel structures constructed of exterior and interior metal panels.

FIG. 4 depicts a single tongue and review panel join assembly according to yet another embodiment of the present disclosure, there a pair of first gaskets are disposed about the outer vertical edges of a first frame member and its' associated tongue or male portion and a second gasket is disposed within opposing groove or female portion of a second frame member.

FIG. 4a depicts another embodiment according to the present disclosure, wherein first and second frame members both include a pair of groove or female portions and are mirror images of one another, and having a pair of first gaskets disposed about the outer vertical edges of the first or second frame member and a pair of second gaskets disposed within the pair of groove or female portions of either said first or second frame member.

FIG. 4b depicts still another embodiment according to the present disclosure wherein a double tongue and groove frame assembly is sealed by disposing a pair of first gaskets about opposite sides of the outer vertical edges of a first frame member having a pair of tongue or male positions forming therebetween a groove or female portion and wherein a second gasket is disposed within the groove or female portion of the first frame member for sealing engagement with a tongue or male portion from an oppositely disposed second frame member.

FIG. 4c depicts a butyl free panel joint assembly according to the prior art, wherein a double tongue and groove frame assembly is sealed by disposing a pair of first gaskets about opposite sides of the outer vertical edges of a first frame member having a pair of tongue or male positions forming therebetween a groove or female portion and a pair of second gaskets are disposed within a pair of groove or female portions of a second frame member for sealing engagement with a tongue or male portion from an oppositely disposed first frame member.

### DETAILED DESCRIPTION OF THE PREFERRED EMBODIMENT

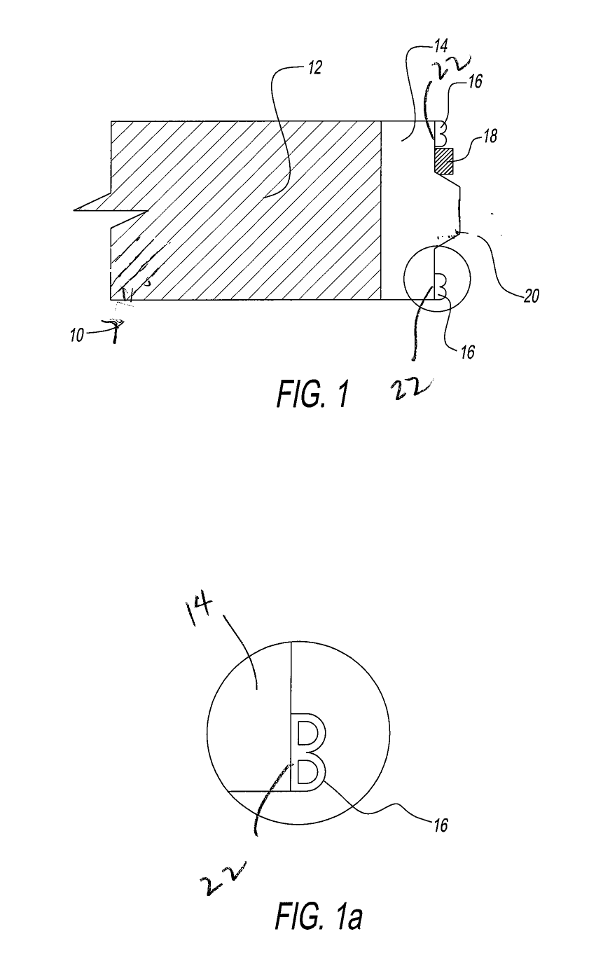

This disclosure can best be described by referring to the figures wherein FIG. 1 is a schematic representation with portions broken away of a freezer panel joint assembly 10 having an insulation panel 12 and a framing member 14, in turn having tongue or male portion 20 of a tongue and groove panel joint with the first gaskets 16 disposed on opposite sides of tongue portion 20 and further having a second gasket 18 disposed between tongue portion 20 and one of first gaskets 16. In particular, FIG. 1 depicts a broken away portion of a insulation panel 12 which shows the panel edge of or vertical cross section therethrough. FIG. 1 shows: (1) an edge of or vertical section through framing member 14, including through tongue portion 20 of the framing member vertical section lines through framing member 14, not shown); (2) a vertical section through a first gasket 16; and (3) a vertical section through a second gasket 18 (highly shaded), that lies along and above tongue portion 20, between the first gasket 16 and tongue portion 20.

If one or more adhesive gaskets is or are employed for either adhesive, it or they can be applied at any suitable location, e.g., about the base and/or side wall and/or top wall 22 of tongue portion 20, and tongue portion 20 is applied to the matching groove of a grooved frame member (not shown in FIG. 1), to join the framing members together, and hence the appended panels together.

The gasket configuration about tongue portion 20 is specifically designed to place gasket 18 as close to the exterior or warm side of the panel as possible to eliminate the possibility of vapor transmission into the joint. This location immediately stops any vapor that may pass first gasket 16 from migrating closer to the interior or freezer temperature edge where it would freeze. A larger gasket or a full width gasket would interfere with the panel joint profile and cause increased dimension of the panel assembly.

A preferred embodiment of this disclosure is shown in FIG. 1. More particularly, there is disclosed a butyl-free freezer panel joint assembly which comprises a pair of elongated interfacing substantially flat surfaces of tongue and groove framing member 14. The framing member 14 has vertical outer edges 22. At least one compressible first gasket 16 of polyvinyl chloride is disposed about vertical outer edge 22 of framing member 14. First gasket 16 is affixed to outer vertical edge 22 of framing member 14.

The butyl-free panel joint assembly also includes at least one second gasket 18. It is an adhesive-like material that is compressible and provides a spring-back feature. Second gasket 18 is affixed to at least a portion of the flat surface of outer vertical edge 22 of framing member 14 that lies between first gasket 16 and tongue portion 20 of framing member 14.

FIG. 1(a) is an enlarged view of a portion of first gasket 16 as would be seen from outer vertical edge 22 of framing member 14 of FIG. 1. Although FIG. 1 shows that first gasket 16 is solid, it can be flexible. The enlarged FIG. 1(a) shows the gasket can be hollow and flexible.

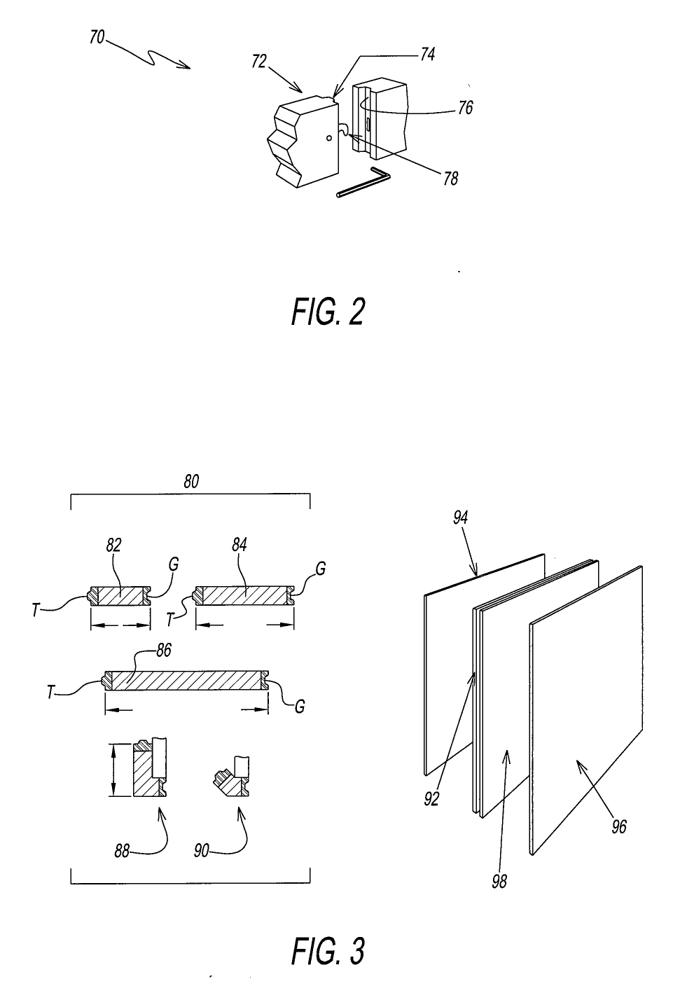

FIG. 2 shows a side perspective view of a panel joint 70 comprised of a joint assembly 72 in turn comprised of a joint tongue 74 and groove 76, the tongue and groove members being fastened by a cam-lock fastener according to the present disclosure. As the tongue and groove frame members are advanced toward each other, the hook is passed over and latches onto a short bar extending orthogonally across the groove, and a ratchet wrench (not shown) is rotated to pull the tongue and groove portions of the frame member tightly together.

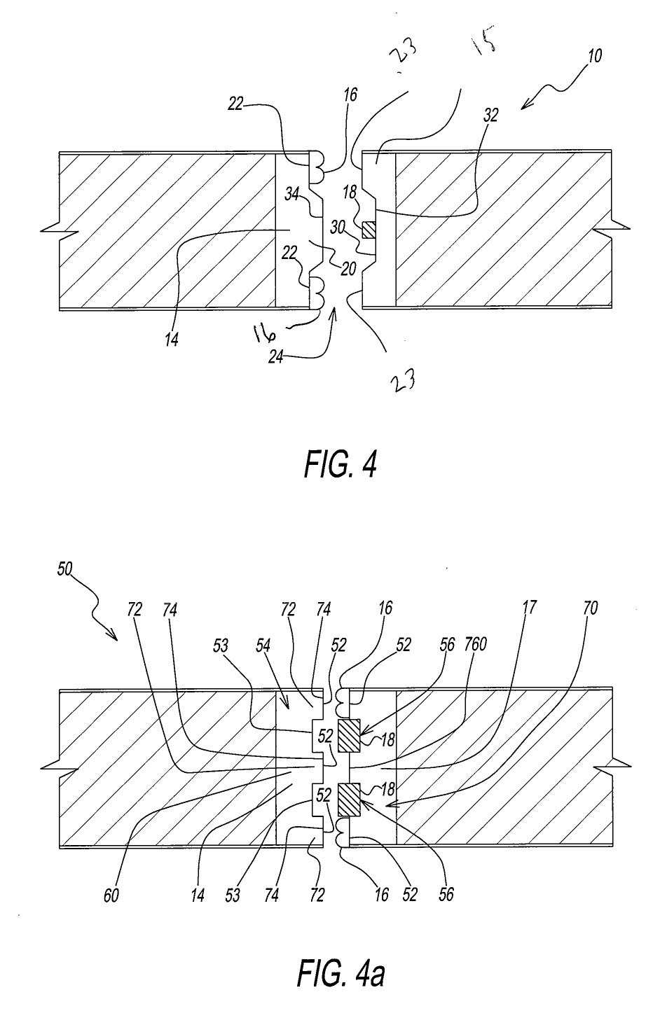

FIG. 3 shows panel joint assemblies 80, comprised of panels 82, 84, 86, 88, and 90, each having different dimensions, e.g., standard wall panels, according to the present disclosure. FIG. 3 also shows various assemblies employed for wood frame members 92 constructed by use of alternative tongue and groove joint panels for ultimate use in multi-panel structures constructed of exterior and interior metal panels, 94, 96 and interior framed panels 98 covered with urethane.

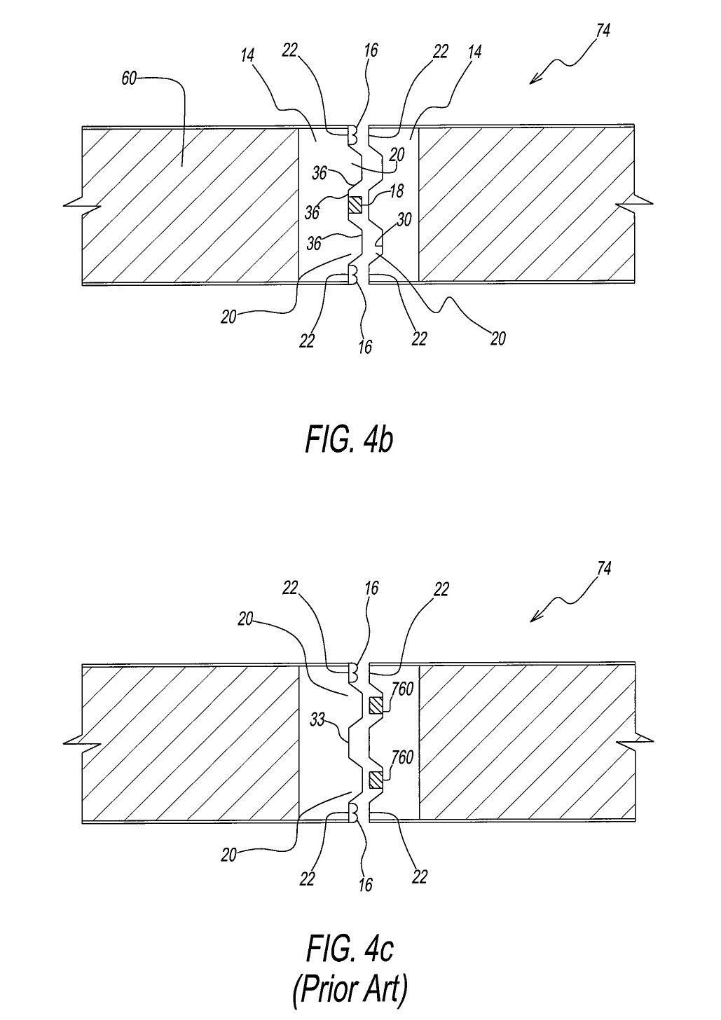

FIG. 4 is another embodiment according to the present disclosure comprising a butyl-free freezer panel joint assembly 10, which comprises:

a pair of oppositely disposed elongated interfacing substantially flat vertical outer edges 22, 23 of oppositely disposed framing members 14, 15;

at least one pair of compressible gaskets 16, made of polyvinyl chloride, are disposed about opposite sides of tongue portion 20 of framing member 14;

wherein each first gasket 16 is affixed to at least a portion of elongated interfacing substantially flat vertical outer edges 22; and

at least one second gasket 18 formed of an adhesive-like material that is compressible and exhibits an elastomeric resilient property, wherein second gasket 18 is affixed to the surface of recessed female inner wall 30 of groove 32 that interfaces with the opposing projecting interfacing wall 34 of tongue portion 20, such that the second gasket lies offset from the vertical plane of first gasket 16 and from tongue portion 20 of framing member 14 of panel joint 24.

FIG. 4(a) discloses a butyl-free freezer panel joint assembly 50, which comprises:

a plurality of elongated interfacing substantially flat vertical edges 52 of framing members 54, 70 and oppositely disposed cavity members 53 and 56 formed between edges 52,

wherein a first gasket 16 is affixed to at least a portion of the interfacing substantially flat surfaces of the panel joint running near and along each of the vertical parallel outer edges of the panel joint;

wherein the projection mold comprises a main body 60, and a mirror image 70 of the main body, the main body having three parallel arms, each of equal length, each extending horizontally and at right angles from the main body, and each arm of the main body having a flat vertical face 74 that meets the flat vertical face of the opposed arms thereby to form at least two separate enclosed cavities 56;

wherein at least two first gaskets of compressible polyvinyl chloride are spaced from and vertically aligned with each other, and are disposed in and about the two projection molds and two cavities 56 for a panel joint;

wherein the first gasket is affixed to at least a portion of the interfacing substantially flat surfaces of the panel joint running near and along each of the vertical and parallel outer edges of the panel joint;

at least two second gaskets 18, said second gaskets being an adhesive-like material that is compressible and provides a spring-back feature, wherein said at least two second gaskets are formed in and affixed to the interfacing surfaces of the framing member, such that the second gaskets 18 are aligned between the first gaskets 16 and with each other between the projection mold portion 50 of the framing member of the panel joint.

FIG. 4b discloses butyl-free freezer panel joint assembly 60, which comprises:

a pair of elongated interfacing substantially flat surfaces of double tongue 20 and double groove 36 framing members 14, the framing members having vertical outer edges 22;

at least one first compressible gasket of polyvinyl chloride 16 is disposed above or about the tongues 20 of the double tongue 36-36 and double groove 30-30 versions of the of the panel joint;

wherein the first gasket 16 is affixed to at least a portion of the interfacing substantially flat surfaces 22 of the panel joint running near and along each of the vertical parallel outer edges of the panel joint;

at least one second gasket 18, said second gasket being an adhesive-like material that is compressible and provides a spring-back feature, wherein said at least one second gasket 18 is affixed to the surface 36 of the recessed inner wall of the centrally located groove that is vertically aligned between and with the first gaskets 16 and interfaces with the opposing projecting interfacing outer wall of the tongue, such that the second gasket lies in the vertical plane of the first gaskets and is aligned with the double tongue portion of the framing member of the panel joint.

A butyl-free freezer panel joint assembly, which comprises:

a pair of elongated interfacing substantially flat surfaces of double tongue and double groove framing members, the framing members having vertical outer edges;

at least one first compressible gasket of polyvinyl chloride is disposed about the tongues of the double tongue and double groove panel joint;

wherein the first gasket is affixed to at least a portion of the interfacing substantially flat surfaces of the panel joint running near and along each of the vertical parallel outer edges of the panel joint;

at least one second gasket, said second gasket being an adhesive-like material that is compressible and provides a spring-back feature, wherein said at least one second gasket is affixed to the surface of the recessed inner wall of the centrally located groove that is between and is aligned with the first gaskets and interfaces with the opposing projecting interfacing outer wall of the tongue, such that the second gasket lies in the vertical plane of the first gaskets and is aligned with the double tongue portion of the framing member of the panel joint.

FIG. 4(c) depicts the prior art in which a double tongue and double groove is employed wherein first gaskets 16 are not in vertical alignment with the second gaskets 18.

This application discloses in FIGS. 4 through 4(b) a butyl-free freezer panel joint assembly, which comprises a pair of elongated interfacing substantially flat surfaces of double tongue and double groove framing members. The framing members have vertical outer edges. The framing members have at least one first compressible gasket disposed about the tongues of the double tongue and double groove panel joint.

The first gasket is affixed to at least a portion of the interfacing substantially flat surfaces of the panel joint running near and along each of the vertical parallel outer edges of the panel joint.

This application also discloses two second gaskets. Each second gasket is an adhesive-like material that is compressible and provides a spring-back feature. Each of the two second gaskets 760 is affixed to an inner rear surface of the recessed inner wall of each of the centrally located grooves. Neither of the centrally located grooves, and neither of the second gaskets affixed to the centrally located grooves is between or aligned with the first gaskets, and interfaces with the opposing projecting interfacing outer wall of the tongue, such that the second gaskets lie in the vertical plane of the first gaskets and is aligned with the double tongue portion of the framing member of the panel joint.

While I have shown and described several embodiments in accordance with my disclosure, it is to be clearly understood that the same may be susceptible to numerous changes apparent to one skilled in the art. Therefore I do not wish to be limited to the details shown and described but intend to show all changes and modifications that come within the scope of this disclosure.

What is claimed is:

1. A butyl-free freezer panel joint assembly, which comprises:
a pair of elongated interfacing substantially flat surfaces of tongue and groove framing members, the framing members having vertical outer edges;
at least one first compressible gasket of polyvinyl chloride disposed about the tongue of a tongue and groove panel joint;
wherein the first gasket is affixed to at least a portion of the interfacing substantially flat surfaces of the panel joint running near and along each of the vertical parallel outer edges of the panel joint;
at least one second gasket, said second gasket being an adhesive-like material that is compressible and provides a spring-back feature, wherein said at least one second gasket being affixed to at least a portion of the flat surfaces of the interfacing surfaces of the framing member that lies between the first gasket and the tongue portion of the framing member of the panel joint.

2. The butyl-free freezer panel joint assembly of claim 1, wherein the first and second gaskets are affixed to the interfacing substantially flat surface portions of the joint of the framing member by a suitable fastener that adheres the first and second gaskets to each other.

3. The butyl-free freezer panel joint assembly of claim 1, wherein the at least one first gasket of polyvinyl chloride, is foam.

4. The butyl-free freezer panel joint assembly of claim 1, wherein the first and second gaskets are affixed by a chemical adhesive to each other and to the interfacing substantially flat-surface portions of the joint of the panels of the framing member.

5. The butyl-free freezer panel joint assembly of claim 1, wherein at least the first gasket is affixed by a suitable fastener to at least a portion of the interfacing substantially flat-surface portions of the panel joint of the framing member.

6. The butyl-free freezer panel joint assembly of claim 1, wherein the first gasket is an extruded polyvinyl chloride based foam polymers whose profile is for general gasketing purposes, whether alone or with other materials, such as an optional pressure sensitive adhesive and a special grade polyvinyl chloride foam polymer extrusion.

7. The butyl-free freezer panel joint assembly of claim 1, wherein the second gasket is a thermoplastic elastomer with enhanced temperature and chemical resistance for demanding applications, and for providing faster compression recovery than polyvinyl chloride foams.

8. The butyl-free freezer panel joint assembly of claim 1, wherein said first gasket is selected from the fasteners selected from the group consisting of: a high tack adhesive, a chemical adhesive fastener, and an aqueous-based acrylic pressure sensitive adhesive.

9. The butyl-free freezer panel joint assembly of claim 1, wherein first and second gaskets are affixed to the interfacing flat-surface portions of the joint of the framing member by any suitable fastener that adheres to a surface of the first and second gaskets and to the surfaces of the panels of the framing members adjacent to the tongue portion.

10. A butyl-free freezer panel joint assembly, which comprises:
a pair of elongated interfacing substantially flat surfaces of tongue and groove framing members, the framing members having vertical outer edges;
at least one first compressible gasket of polyvinyl chloride disposed about the tongue of the tongue and groove panel joint;
wherein the first gasket is affixed to at least a portion of the interfacing substantially flat surfaces of the panel joint running near and along each of the vertical parallel outer edges of the panel joint;
at least one second gasket, said second gasket being an adhesive-like material that is compressible and provides a spring-back feature, wherein said at least one second gasket is affixed to the surface of the recessed inner wall of the groove that interfaces with the opposing projecting interfacing wall of the tongue, such that the second gasket lies offset from the vertical plane of the first gaskets and from the tongue portion of the framing member of the panel joint.

11. A butyl-free freezer panel joint assembly, which comprises:
a pair of elongated interfacing substantially flat surfaces of a projection mold and associated cavity framing members, the framing members having vertical outer edges,
wherein the first gasket is affixed to at least a portion of the interfacing substantially flat surfaces of the panel joint running near and along each of the vertical parallel outer edges of the panel joint;
wherein the projection mold comprises a main body, and a mirror image of the main body, the main body having three parallel arms, each of equal length, each extending horizontally and at right angles from the main body, and each arm of the main body having a flat vertical face that meets the flat vertical face of the opposed arms thereby to form at least two separate enclosed cavities;
wherein at least two first gaskets of compressible polyvinyl chloride are spaced from and vertically aligned with each other, and are disposed in and about the two projections molds and two cavities for a panel joint;
wherein the first gasket is affixed to at least a portion of the interfacing substantially flat surfaces of the panel joint running near and along each of the vertical and parallel outer edges of the panel joint;
at least two second gaskets, said second gaskets being an adhesive-like material that is compressible and provides a spring-back feature, wherein said at least two second gaskets are formed in and affixed to the interfacing surfaces of the framing member, such that the second gaskets are aligned between the first gaskets and with each other between the projection mold portion of the framing member of the panel joint.

12. A butyl-free freezer panel joint assembly, which comprises:
a pair of elongated interfacing substantially flat surfaces of double tongue and double groove framing members, the framing members having vertical outer edges;
at least one first compressible gasket of polyvinyl chloride is disposed about the tongues of the double tongue and double groove panel joint;
wherein the first gasket is affixed to at least a portion of the interfacing substantially flat surfaces of the panel joint running near and along each of the vertical parallel outer edges of the panel joint;
at least one second gasket, said second gasket being an adhesive-like material that is compressible and provides a spring-back feature, wherein said at least one second gasket is affixed to the surface of the recessed inner wall of the centrally located groove that is between and is aligned with the first gaskets and interfaces with the opposing projecting interfacing outer wall of the tongue, such that the second gasket lies in the vertical plane of the first gaskets and is aligned with the double tongue portion of the framing member of the panel joint.
